(19) United States
(12) Patent Application Publication
(10) Pub. No.: US 2025/0168786 A1
(43) Pub. Date: May 22, 2025

(54) TESTING FRAMEWORK FOR UE TIMING-TRACKING CAPABILITIES OVER SATELLITE OR SIMILAR COMMUNICATIONS

(71) Applicant: Nokia Technologies Oy, Espoo (FI)

(72) Inventors: Rafhael MEDEIROS DE AMORIM, Aalborg (DK); Jeroen WIGARD, Aalborg (DK); Frank FREDERIKSEN, Aalborg (DK); Konstantinos MANOLAKIS, mUNICH (DE)

(21) Appl. No.: 18/833,178

(22) PCT Filed: Feb. 2, 2022
(86) PCT No.: PCT/EP2022/052424

§ 371 Date: Jul. 25, 2024

(51) Int. Cl. H04W 56/00; H04W 24/06; H04W 64/00; H04W 84/06

(52) U.S. Cl. CPC H04W 56/001; H04W 24/06; H04W 64/006; H04W 84/06

(57) ABSTRACT

Common delay(s) are set for a base station, the base station and a UE able to communicate via signals and to use the common delay(s) in communication. The common delay(s) correspond to delay in communication of the signals in a path from a simulated satellite to a reference point, which is a point selected between the base station and the simulated satellite. The UE is placed in a known location. Ephemeris values are set for the base station for the simulated satellite and caused to be broadcasted toward the UE. The ephemeris values represent positioning of the simulated satellite through which the signals are supposed to travel. In response to communication over the path by the UE, error is determined corresponding to at least timing at least between the UE and the reference point.

### TECHNICAL FIELD

Exemplary embodiments herein relate generally to terrestrial networks (TNs), such as cellular systems, and non-terrestrial networks (NTNs) such as satellite communication systems, and, more specifically, relates to testing in these systems.

### BACKGROUND

In cellular systems, the time and frequency resources are usually divided into regular patterns (referred to as frames) that allow the different UEs (user equipment, a wireless, typically mobile device) to access the system using different resources. In 5G (fifth generation) systems the gNB (a base station for 5G) may serve several users concomitantly, being responsible to allocate resources (time and frequency divisions) to the several users at the same time. In UL (uplink, from a UE to the network via the base station), in order to enable resource allocation for all those users, who are at different distances from the gNB, the UEs are to apply timing advance (TA) at their transmissions, aiming at arriving at synchronous instants at the gNB.

In terrestrial networks (TNs), the timing advance is estimated by the gNB after a RA (random-access) transmission is made by the UE, using a set of predefined preambles, and the time alignment in UL is maintained over the duration of the connection by means of very small corrections by the UE, and timing advance commands generated by the gNB. The updates made for the UE-side aim at maintaining the uplink synchronization requirements as the ones defined by RAN4 in 3GPP (third generation partnership project).

In NTN (non-terrestrial networks), such as satellite communication systems, there is a concept of a “common delay, which is the delay between the satellite and an entity, usually a gateway (GW), on the ground. The common delays observed between the UE and a satellite at hundreds of kilometers of distance are much larger than those typically observed at the TN. As a consequence, the RA preambles and RACH procedure as compared to the TN are not designed to enable a correct detection of the RA attempt and a proper round-trip delay estimation. Moreover, for LEO (low-Earth orbit) satellite types, the ultra-high speeds observed—in the order of approximately 7.5 kilometers/second—causes the delay to vary rapidly. Because of this, the delay corrections cannot be managed by the legacy frequency tracking and corrections allowed at the UE side, and instead more advanced tracking models are needed; also, the amount of timing advance commands required for maintaining such connection would create a massive overhead in the physical layer resources.

### BRIEF SUMMARY

This section is intended to include examples and is not intended to be limiting.

In an exemplary embodiment, a method is disclosed that includes setting one or more common delays for a base station. The base station and a user equipment are able to communicate via signals and to use the one or more common delays in communication. The one or more common delays correspond to delay in communication of the signals in a path from a simulated satellite to a reference point, where the reference point is a point selected between the base station and the simulated satellite and where the user equipment is placed in a known location. The method includes setting ephemeris values for the base station for the simulated satellite and causing the ephemeris values to be broadcasted toward the user equipment. The ephemeris values represent positioning of the simulated satellite through which the signals are supposed to travel. The method further includes, in response to communication over the path by the user equipment, determining error corresponding to at least timing at least between the user equipment and the reference point.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to at least to: set one or more common delays for a base station, the base station and a user equipment able to communicate via signals and to use the one or more common delays in communication, wherein the one or more common delays correspond to delay in communication of the signals in a path from a simulated satellite to a reference point, where the reference point is a point selected between the base station and the simulated satellite and where the user equipment is placed in a known location; set ephemeris values for the base station for the simulated satellite and causing the ephemeris values to be broadcasted toward the user equipment, wherein the ephemeris values represent positioning of the simulated satellite through which the signals are supposed to travel; and in response to communication over the path by the user equipment, determine error corresponding to at least timing at least between the user equipment and the reference point.

An exemplary computer program product includes a computer-readable storage medium bearing computer program code embodied therein for use with a computer. The computer program code includes: code for feeding a user equipment that has been placed in a location with position information for the user equipment, the position information corresponding to a global satellite navigation system; code for setting one or more common delays for a base station, the base station and a user equipment able to communicate via signals and to use the one or more common delays in communication, wherein the one or more common delays correspond to delay in communication of the signals in a path from a simulated satellite to a reference point, where the reference point is a point selected between the base station and the simulated satellite and where the user equipment is placed in a known location; code for setting ephemeris values for the base station for the simulated satellite and causing the ephemeris values to be broadcasted toward the user equipment, wherein the ephemeris values represent positioning of the simulated satellite through which the signals are supposed to travel; and code, in response to communication over the path by the user equipment, for determining error corresponding to at least timing at least between the user equipment and the reference point.

In another exemplary embodiment, an apparatus comprises means for performing: setting one or more common delays for a base station, the base station and a user equipment able to communicate via signals and to use the one or more common delays in communication, wherein the one or more common delays correspond to delay in communication of the signals in a path from a simulated satellite to a reference point, where the reference point is a point selected between the base station and the simulated satellite and where the user equipment is placed in a known location; setting ephemeris values for the base station for the simulated satellite and causing the ephemeris values to be broadcasted toward the user equipment, wherein the ephemeris values represent positioning of the simulated satellite through which the signals are supposed to travel; and in response to communication over the path by the user equipment, determining error corresponding to at least timing at least between the user equipment and the reference point.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 1A is a block diagram illustrating an exemplary configuration for some of the elements in FIG. 1;

FIG. 2 is one exemplary framework that may be used in exemplary embodiments;

FIG. 3 is a logic flow diagram of an exemplary testing procedure, Test A, in accordance with an exemplary embodiment;

FIG. 4 is a logic flow diagram of an exemplary testing procedure, Test B, in accordance with an exemplary embodiment;

FIG. 5 is a logic flow diagram of an exemplary testing procedure, Test C, in accordance with an exemplary embodiment;

FIG. 6 is a logic flow diagram of an exemplary testing procedure, Test D, in accordance with an exemplary embodiment;

FIG. 7 is a logic flow diagram of an exemplary testing procedure, Test E, in accordance with an exemplary embodiment;

FIG. 8 is a logic flow diagram of an exemplary testing procedure, Test F, in accordance with an exemplary embodiment; and

FIG. 9 is a logic flow diagram that can be used in any of the Tests A-F, in accordance with an exemplary embodiment.

### DETAILED DESCRIPTION OF THE DRAWINGS

Abbreviations that may be found in the specification and/or the figures and/or are defined below, at the end of the detailed description section. That is, if a definition for an abbreviation has not already been defined in the specification or in the figures, a definition is provided in a list below at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as either “or”, “and”, or “both”.

The exemplary embodiments herein describe techniques for testing framework for UE timing-tracking capabilities over satellite or similar communications. Additional description of these techniques is presented after a system into which the exemplary embodiments may be used is described.

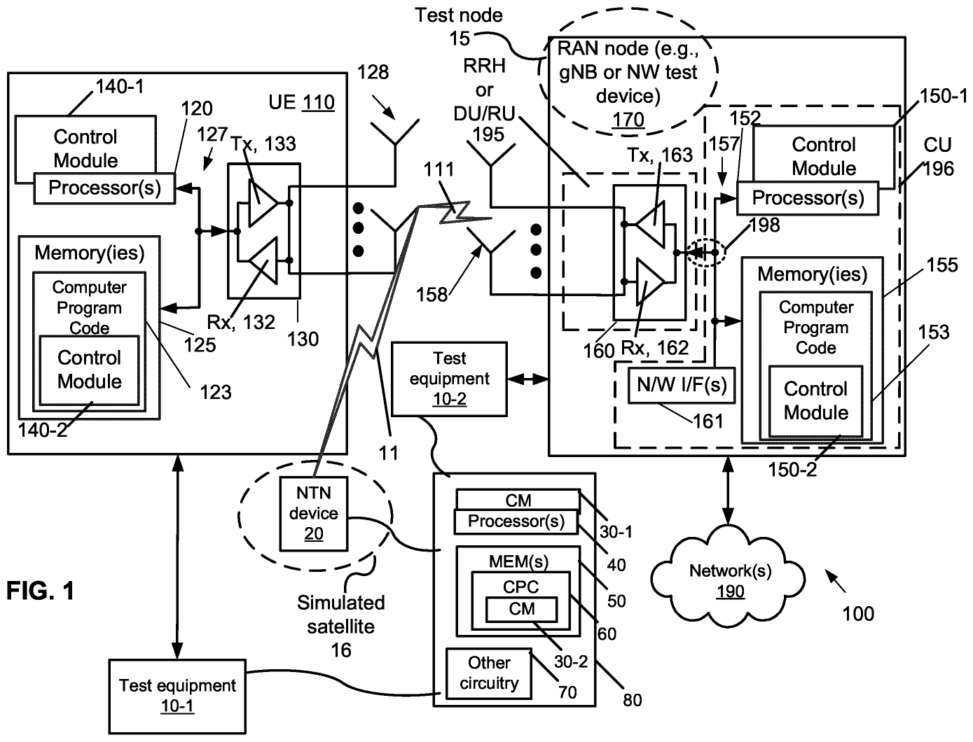

Turning to FIG. 1, this figure shows a block diagram of one possible and non-limiting exemplary system in which the exemplary embodiments may be practiced. A user equipment (UE) 110, radio access network (RAN) node 170, and network(s) 190 are illustrated. In FIG. 1, a user equipment (UE) 110 is in wireless communication with a RAN node 170 in this testing framework 100. The testing framework may include one or both of test equipment 10-1 and 10-2, described below. There may be an NTN device 20 that is used for the testing, as described below, or the NTN device 20 may perform NTN signal emulation. The NTN device 20 communicates at least with the UE 110 via a wireless link 20. In certain situations, the NTN device 20 may be a simulated satellite 16, such that testing may be performed using a simulated version of a real satellite, including any necessary signals or other corresponding information to make the simulated satellite 16 be considered to be a real satellited by the UE and/or gNB. The simulated satellite may be implemented as a GNSS satellite, or an NTN communication-capable satellite, which may not be part of a GNSS but can communicate using the GNSS. Additionally, while the primary examples used herein refer to GNSS, GNSS is an example used for describing the exemplary embodiments, and other similar positioning methods can be applied to other positioning systems.

A UE is a wireless, typically mobile device that can access a wireless network. The UE 110 includes circuitry comprising one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 is a base station that provides access by wireless devices such as the UE 110 to a wireless network. Typically, the RAN node is referred to as a gNB, although as described below, this is only one example. The RAN node 170 may be, for instance, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (e.g., the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by one gNB-DU. The gNB-DU terminates the F1 interface 198 connected with the gNB-CU. Note that the DU 195 is considered to include the transceiver 160, e.g., as part of an RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station.

The RAN node 170 includes circuitry comprising one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a control module 150, comprising one of or both parts 150-1 and/or 150-2, which may be implemented in a number of ways. The control module 150 may be implemented in hardware as control module 150-1, such as being implemented as part of the one or more processors 152. The control module 150-1 may be implemented also as an integrated circuit or through other hardware such as a programmable gate array. In another example, the control module 150 may be implemented as control module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the control module 150 may be distributed, such as being distributed between the DU 195 and the CU 196, or be implemented solely in the DU 195.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, e.g., fiber optic cable or other suitable network connection to connect the other elements (e.g., a central unit (CU), gNB-CU) of the RAN node 170 to the RRH/DU 195. Reference 198 also indicates those suitable network link(s).

The one or more network interfaces 161 communicate over a network 190. Network(s) 190 may allow two or more RAN nodes 170 to communicate and/or may allow the RAN node 170 to communicate with a core network such as a 5GC (fifth generation core network). For the sake of the testing framework 100, the network(s) 190 may or may not be accessed, and generally might not be accessed.

The test equipment 10-1 is used to interface with the UE 110, such as to feed the UE with position information. The test equipment 10-2 may be used to interface with the gNB 170, such as to set ephemeris values, verify timing, compare deviation of transmit timing with ideal transmit timings, and the like. The NTN device 20 may be an actual NTN device such as a satellite that is used by the UE to set GNSS signals. The NTN device 20 may be an emulator that emulates GNSS signals. Further, the NTN device 20 may be an emulator that emulates NTN communication signals. It is noted that while a base station (e.g., gNB 170) is primarily described herein for the testing procedures, a network test device 170 may be used instead of the base station. Such network test devices are known, although the use of them with respect to the exemplary embodiments herein is not. It is further noted that the base station 170 or network test device 170 may be referred to as a test node 15.

Each of the test equipment 10-1 and 10-2 and/or the NTN device 20 may be implemented by the apparatus 80, which comprises circuitry comprising one or more processors 40, one or more memories (MEM(s)) 50, and other circuitry 70. The one or more memories 50 include computer program code (CPC) 60. The apparatus 80 includes a control module (CM) 30, comprising one of or both parts 30-1 and/or 30-2, which may be implemented in a number of ways. The control module 30 may be implemented in hardware as control module 30-1, such as being implemented as part of the one or more processors 40. The control module 30-1 may be implemented also as an integrated circuit or through other hardware such as a programmable gate array. In another example, the control module 30 may be implemented as control module 30-2, which is implemented as computer program code 60 and is executed by the one or more processors 40. For instance, the one or more memories 50 and the computer program code 60 are configured to, with the one or more processors 40, cause the apparatus 80 to perform one or more of the operations as described herein.

It is noted that two test equipment 10-1 and 10-2 are shown. These may be combined into a single test equipment.

The computer readable memories 125, 155, and 50 may be of any type suitable to the local technical environment and may be implemented using any suitable data storage technology, such as semiconductor-based memory devices, flash memory, magnetic memory devices and systems, optical memory devices and systems, fixed memory and removable memory. The computer readable memories 125, 155, and 50 may be means for performing storage functions. The processors 120, 152, and 40 may be of any type suitable to the local technical environment, and may include one or more of general-purpose computers, special purpose computers, microprocessors, digital signal processors (DSPs) and processors based on a multi-core processor architecture, as non-limiting examples. The processors 120, 152, and 40 may be means for performing functions, such as controlling the UE 110, apparatus 80, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, vehicles with a modem device for wireless V2X (vehicle-to-everything) communication, image capture devices such as digital cameras having wireless communication capabilities, gaming devices having wireless communication capabilities, music storage and playback appliances having wireless communication capabilities, Internet appliances (including Internet of Things, IoT, devices) permitting wireless Internet access and possibly browsing, IoT devices with sensors and/or actuators for automation applications with wireless communication tablets with wireless communication capabilities, as well as portable units or terminals that incorporate combinations of such functions.

Turning to FIG. 1A, this figure is a block diagram illustrating an exemplary configuration for some of the elements in FIG. 1. A UE 110 communicates to a BS (base station, such as RAN node) 170 via a path 35. One part of path 35 is 35-1, between the UE 110 and simulated satellite 16, and another part of path 35 is 35-2 between the simulated satellite 16 and the BS 170. The test equipment 10 in this example communicates with the UE 110 and the BS 170, to control many or all of the analyses for the timing-tracking capabilities over satellite communications described herein.

There is a reference point 45, and as reference 46 indicates, the reference point 45 can be any point specified by the base station 170 between the base station 170 and satellite 16 (this is the definition of reference point in 3GPP NTN, e.g., as discuss in RAN1 #107-e). Note also that the reference point 45 may also be the base station 170.

Having thus introduced one suitable but non-limiting technical context for the practice of the exemplary embodiments, the exemplary embodiments will now be described with greater specificity.

To deal with the two challenges mentioned above (i.e., the very large delays and the rapid changes on the delay), the NTN specifications have provided more autonomy for the UE. Using the formula below, it has been agreed that the UE will compensate autonomously part of TA, namely UE-specific TA, whereas other parts of the TA, which are common for all UEs, will be provided by the network. See, e.g., Final Report of 3GPP TSG RAN WG1 #104-e v1.0.0 (Online meeting, 25th January-5th February 2021). One such agreement (see Final Report of 3GPP TSG RAN WG1 #104bis-e v1.0.0 (Online meeting, 12th-20th April 2021)) is shown between the opening and closing quotation marks below.

“The Timing Advance applied by an NR NTN UE

in RRC IDLE/INACTIVE and RRC_CONNECTED is given by:

$${T}_{TA} = ( {N}_{TA} + {N}_{TA , UE - specific} + {N}_{TA , common} + {N}_{TA , offset} ) \times {T}_{c}$$

Where:

N_{TA} is defined as 0 for PRACH and updated based on TA Command field in msg2/msgB and MAC CE TA command.

FFS: details of NTA update/accumulation.

N_{TA,UE-specific} is UE self-estimated TA to pre-compensate for the service link delay.

N_{TA,common} is network-controlled common TA, and may include any timing offset considered necessary by the network.

N_{TA,common} with value of 0 is supported.

FFS: details of signaling including granularity.

N_{TA,offset} is a fixed offset used to calculate the timing advance.”

Compared to the formulation used for TN, there are two new components in this formula: N_{TA,UE-specific} and N_{TA,common}. These two parameters are created such that the UE autonomy, supported by GNSS and satellite ephemeris information, is used for enabling very large timing advance values, with fast updates. However, the problem arises because none of these values are deterministic beforehand. That is, by knowing the DL reference time, it is not possible to estimate what the transmission time will be. The reasons include the following:
1) External sources of GNSS and satellite ephemeris introducing some potential inaccuracy.
2) Aging of the provided information from the gNB due to satellite movement.
3) The UE has to interpolate—at its own intervals—the functions for the satellite movement and common delay function.

Therefore, there is no common understanding of a deterministic point in time the transmission should occur, which can be determined beforehand.

The N_{TA,UE-specific} is an estimation of the delay between UE and the satellite (i.e., service link delay). This estimation depends on the accuracy of the UE position information, and the accuracy of the ephemeris position (e.g., satellite position and orbital velocity) at the UE side. The UE position, which according to Rel-17 NTN Agreements shall be acquired via GNSS, cannot be controlled via RAN, depends on the quality of the GNSS hardware at the UE, and is subject to several sources of error, such as unavailability of GNSS satellites, external threats, altitude modelling, and the accuracy of the GNSS. Likewise, the ephemeris estimation is also subject to inaccuracies, as the estimation is provided at certain points in time from the satellite to the gNB. Moreover, the UE needs to acquire satellite position and velocity and interpolate or even extrapolate this information for some time interval. The age of the ephemeris information as well as the quality of the UE modelling algorithm for the orbit are the key sources of ephemeris information inaccuracy.

N_{TA,common} is an estimation of the delay between a so-called reference point (typically gNB) and the satellite. Also, for N_{TA,common}, there are inaccuracies, such as the aging of the information, the finite precision of the parameters used to broadcast the value, given by the number of quantization bits used, as well as the errors in estimation of the feeder link delay by the network itself.

Both N_{TA,UE-specific} and N_{TA,common} are quantized versions of the delay estimations with granularity defined in 5G specifications equal to 16·64/24, (assuming the system subcarrier spacing, SCS, is equal to SCS=15·2^{μ} kHz). The u is a scaling factor that was introduced with NR, where the value of u defines the subcarrier spacing. A value of 0 gives a subcarrier spacing of 15 kHz, while increasing μ to 1 will cause a subcarrier spacing of 30. So μ is a generic way of tuning a system parameter (subcarrier spacing) in a simple and generic way.

Due to the fact that the final UE transmission time will also depend on UE-specific or external estimates (GNSS information, interpolation models, UE measurements, and the like), there is no deterministically defined reference point in time for the UE transmit timing. Following a realistic approach as described above, one can model the different timing components used by the UE as follows:

$${N}_{TA , UE - specific} = \overline{{N}_{TA , UE - specific}} + {X}_{UE - specific} ; and$$

$${N}_{T A , c o m m o n} = \overline{{N}_{T A , c o m m o n}} + {X}_{c o m m o n} ,$$

where N_{TA,UE-specific} and N_{TA,common} are the ideal (“perfect”) estimations for the service link and feeder link delay contributions, respectively, i.e., the values corresponding to an ideal knowledge of the UE and satellite position at the time of transmission, as well as the actual delay on the feeder link. Components X_{UE-specific} and X_{common} represent the error (e.g., inaccuracy) for the same delays as estimated by the UE.

As mentioned, both X_{UE-specific} and X_{common} are dependent on the quality of UE estimation, algorithms and external parameters, as well as the scenario.

However, in order to guarantee compliance of UEs in 3GPP networks, the 3GPP has defined legacy specifications about the transmission time accuracy by the UE side in TN. One proposed updated for this specification regarding the NTN deployments is to allow a maximum transmit error of T_{e,NTN}, where:

$${T}_{e , N T N} = {T}_{e} + {T}_{e , G N S S} + {T}_{e , SAT} , \qquad ( Equation 1 )$$

and where:
Tₑ is the legacy timing error in the TN,
T_{e,GNSS} is the timing error attributed to the GNSS inaccuracies, and
T_{e,SAT} is the timing error attributed to inaccuracies on the ephemeris position.

The transmission timing error (T_{e,NTN}) is the deviation from the transmission reference time, i.e., the downlink reference time (reception time from the synchronization signals in downlink) minus T_{TA} in the formulation above. Notice, however, that T_{TA} is not deterministic (because of X_{UE-specific} and X_{common}), and because even the “ideal” values of N_{TA,UE-specific} and N_{TA,common} are not known to the UE. Due to the fact that the transmission timing error is impacted by those error sources, and not only on a deterministic DL reference as e.g., provided by the SSB or explicit signaling from the gNB, it is not also not straightforward to measure the overall transmit error of T_{e,NTN}, as it is not straightforward to obtain a reference value of what T_{TA} should ideally be.

These issues have been attempted to be solved previously. In legacy procedures, i.e., in terrestrial networks, for instance, the specifications (see ETSI TS 138 133 V16.4.0 (2020-08)) state the following (indicated within opening and closing quotation marks):

“The UE shall meet the Tₑ requirement for an initial transmission provided that at least one SSB is available at the UE during the last 160 ms. The reference point for the UE initial transmit timing control requirement shall be the downlink timing of the reference cell minus (N_{TA}+N_{TA offset})×T_{c}. The downlink timing is defined as the time when the first detected path (in time) of the corresponding downlink frame is received from the reference cell. N_{TA} for PRACH is defined as 0.”

As in TN the DL reception time is defined in a deterministic way, and in the previous case both, N_{TA} and N_{TA,offset} were deterministic (the former assigned by the gNB and the latter hard-coded in the specifications), it could be tested in a lab setup, the compliance of the UE with the specifications. The Tₑ (timing error limit) is given in the specifications by the table 7.1.2-1 (see below) in 3GPP TS 38.133. The maximum error limit varies from 3·64·T_{c} (98 ns) to 12·64·T_{c} (391 ns).

TABLE 7.1.2-1
Tₑ Timing Error Limit

| | | SCS of uplink | |
|---|---|---|---|
| Frequency | SCS of SSB | signals | |
| Range | signals (KHz) | s(KHz) | Tₑ |
| 1 | 15 | 15 | 12 * 64 * T_{c} |
| | | 30 | 10 * 64 * T_{c} |
| | | 60 | 10 * 64 * T_{c} |
| | 30 | 15 | 8 * 64 * T_{c} |
| | | 30 | 8 * 64 * T_{c} |
| | | 60 | 7 * 64 * T_{c} |
| 2 | 120 | 60 | 3.5 * 64 * T_{c} |
| | | 120 | 3.5 * 64 * T_{c} |
| | 240 | 60 | 3 * 64 * T_{c} |
| | | 120 | 3 * 64 * T_{c} |

Note 1:
T_{c} is the basic timing unit defined in TS 38.211 [6]

The test specifications for UE transmission timing are presented in 3GPP TS 38.133. For standalone operation in FR1, the tests are specified in Annex 6.4.1 of the aforementioned document. The first test “NR UE Transmit Timing Test for FR1” is specified in Annex 6.4.1.1. And the specification says the following (shown within the opening and closing quotes):

“The purpose of this test is to verify that the UE can follow frame timing change of the connected gNodeB and that the UE initial transmit timing accuracy, maximum amount of timing change in one adjustment, minimum and maximum adjustment rate are within the specified limits. This test will verify the requirements in clause 7.1.2. ( . . . ) The transmit timing is verified by the UE transmitting SRS using the configuration defined in Table A.6.4.1.1.1-3.”

The document then presents the test configuration for the UE and gNB, which may be assumed the same for the proposed in the exemplary embodiments herein unless mentioned otherwise, without the loss of generality. Some of the UE and gNB configurations used in the test proposed in this invention require the usage of NTN specific parameters. And for the test requirements, so says the document as indicated below (between opening and closing quotation marks):

“The test sequence shall be carried out in RRC_CONNECTED for every test case.

Following will be the test sequence for this test

1) Setup NR PCell according to parameters given in Table A.6.4.1.1.1-1.

2) After connection set up with the cell, the test equipment will verify that the timing of the NR cell is within (N_{TA}+N_{TA_offset})×T_{c}±Tₑ of the first detected path of DL SSB.

a. The N_{TA} offset value (in T_{c} units) is 25600

b. The Tₑ values depend on the DL and UL SCS for which the test is being run and are given in Table 7.1.2-1

3) The test system shall adjust the timing of the DL path by values given in Table A.6.4.1.1.2-1

TABLE A.6.4.1.1.2-1
Adjustment Value for DL Timing

| | Adjustment Value | |
|---|---|---|
| SCS of SSB signals (KHz) | Test1 | Test2 |
| 15 | +64 * 64T_{c} | +32 * 64T_{c} |
| 30 | +32 * 64T_{c} | +16 * 64T_{c} |

4) The test system shall verify that the adjustment step size and the adjustment rate shall be according to requirements specified in clause 7.1.2 Table 7.1.2.1-1 until the UE transmit timing offset is within (N_{TA}+N_{TA_offset})×T_{c}+Tₑ respective to the first detected path (in time) of DL SSB. Skip this step for test 2 with DRX configured.

5) The test system shall verify that the UE transmit timing offset stays within (N_{TA}+N_{TA_offset})×T_{c}±Tₑ of the first detected path of DL SSB. For Test 2 the UE transmit timing offset shall be verified for the first transmission in the DRX cycle immediately after DL timing adjustment”

The step 2 in this test is used to verify, as mentioned, the limits presented in Table 7.1.2-1. In this test, the DL transmission time by the gNB is then adjusted, to emulate relative movement between the test UE and the gNB. The autonomous adjustments by the UE are then measured in order to observe if they are following the limits in specification for autonomous adjustments. At the present time, there is no RAN4 agreements about the autonomous adjustments step sizes (maximum and minimum) allowed in NTN, although they are expected to be higher than in legacy terrestrial networks due to the much higher speed of the satellite and updating of GNSS information by the UE.

One of the problems, as described above, is that estimating the exact time the transmission should take place in NTN−(N_{TA}+N_{TA,UE-specific}+N_{TA,common}+N_{TA,offset}) X T_{c} before the DL reference time-becomes more difficult because the limits for the transmission timing are not deterministic as they are in the legacy scenario-(N_{TA}+N_{TA_offset})×T_{c}. Therefore, in the exemplary embodiments herein, the existing framework is extended to further be able to evaluate in an isolated way the UE's inaccuracies in a scenario emulating a real NTN system.

Another test is described in Annex 6.4.3, called “SA FR1 timing advance adjustment accuracy”, as shown below (and indicated between opening and closing quotation marks):

“The purpose of the test is to verify UE Timing Advance adjustment delay and accuracy requirement defined in clause 7.3. ( . . . )

Each test consists of two successive time periods, with time duration of T1 and T2 respectively. In each time period, timing advance commands are sent to the UE and Sounding Reference Signals (SRS), as specified in table A.6.4.3.1.2-3, are sent from the UE and received by the test equipment. By measuring the reception of the SRS, the transmit timing, and hence the timing advance adjustment accuracy, can be measured.

During time period T1, the test equipment shall send one message with a Timing Advance Command MAC Control Element, as specified in Clause 6.1.3.4 in TS 38.321 [7]. The Timing Advance Command value shall be set to 31, which according to Clause 4.2 in TS 38.213 [3] results in zero adjustment of the Timing Advance. In this way, a reference value for the timing advance used by the UE is established.

During time period T2, the test equipment shall send a sequence of messages with Timing Advance Command MAC Control Elements, with Timing Advance Command value specified in table A.6.4.3.1.2-2. This value shall result in changes of the timing advance used by the UE, and the accuracy of the change shall then be measured, using the SRS sent from the UE.

As specified in Clause 7.3.2.1, the UE adjusts its uplink timing at slot n+k for a timing advance command received in slot n. This delay must be taken into account when measuring the timing advance adjustment accuracy, via the SRS sent from the UE.

( . . . )

A.6.4.3.1.3 Test Requirements

The UE shall apply the signalled Timing Advance value to the transmission timing at the designated activation time i.e., k+1 slots after the reception of the timing advance command, where k=5.

The Timing Advance adjustment accuracy shall be within the limits specified in clause 7.3.2.2.

The rate of correct Timing Advance adjustments observed during repeated tests shall be at least 90%.”

This test identifies if the UE is applying the TA commands precisely, accurately and in the exact time it is expected to do so. This is one of the baselines for the exemplary testing procedures herein.

The test requirements for FR2 are similarly described in the reference (Annex 7.4), conditioned to different parameters and limits that diverge in FR2 compared to FR1.

The exemplary embodiments herein address these and other concerns. First, a brief overview is provided, then additional details are provided.

As an overview, examples herein propose new testing methodology and frameworks to be used to test the compliance of the UEs in terms of their transmit timing error for NTN. An example proposed testing methodology isolates the contributions of the different external information (e.g., GNSS location, ephemeris information) of the new open-loop timing advance (with components compensated autonomously by the UE) to establish uplink reference timings, in order to measure and evaluate if the transmit timing errors are compliant with specifications as given by the formula above and RAN4. Compared to conventional systems, where all elements were deterministic, the new testing can isolate the contribution of each of the variable components. This allows measurement of the UE's time transmission accuracy when receiving each of those inputs (such as DL signals and explicitly signaled commands, GNSS, ephemeris, SSB, synchronization signals, timing advance commands, and the like), and the corresponding time error each of those generates, and which contribute in an additive way to the overall time error.

Moreover, the testing setup may be capable of one or more of the following:
1) Measuring the quality of the UE algorithm for the orbital modelling (with aging information).
2) Measuring the quality of the UE algorithm for the common delay interpolation modelling (e.g., with aging information).
3) Measuring the quality of the UE's method to derive location and/or time/frequency reference from a GNSS input signal and using this reference over a certain time duration.

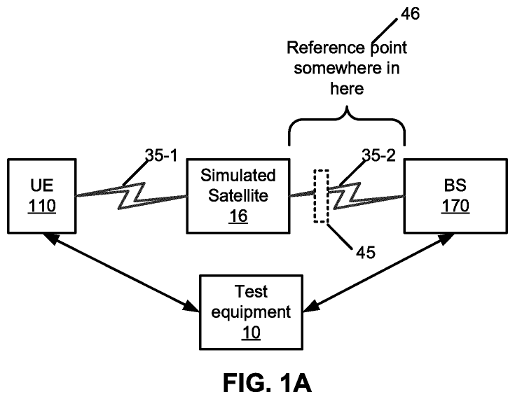

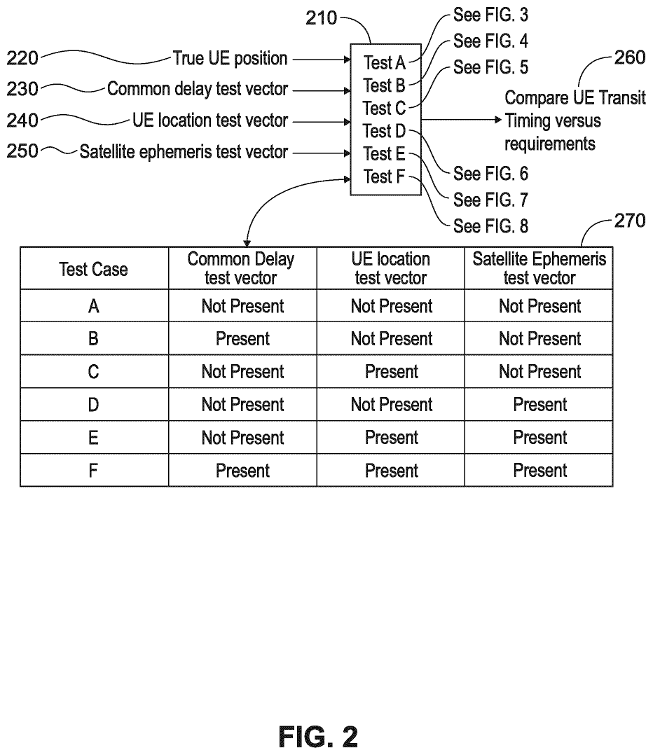

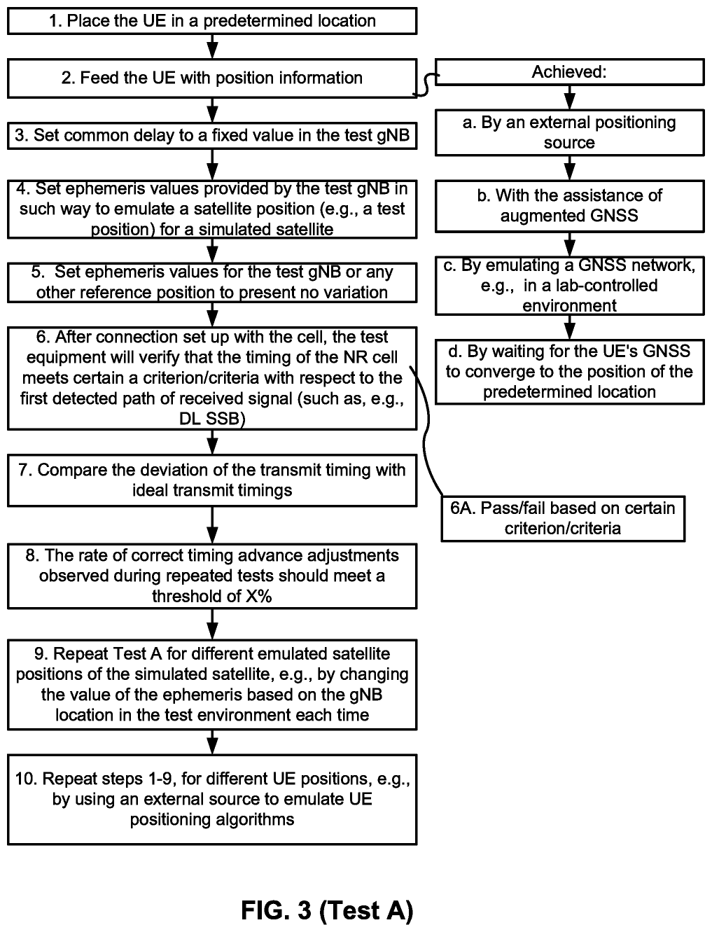

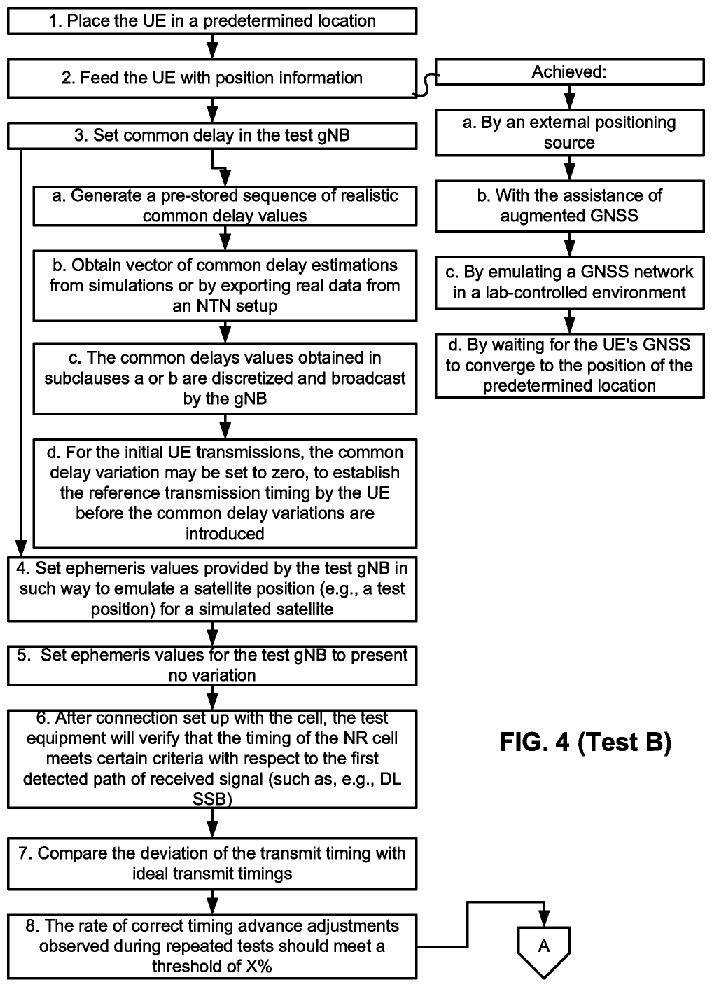

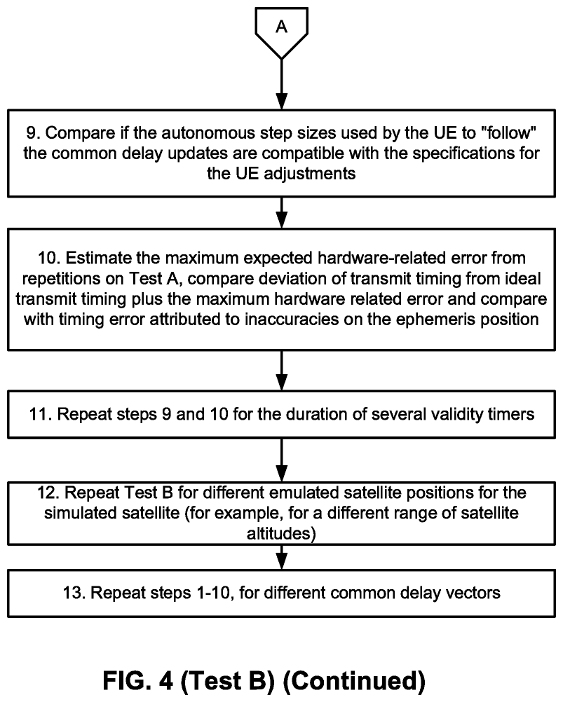

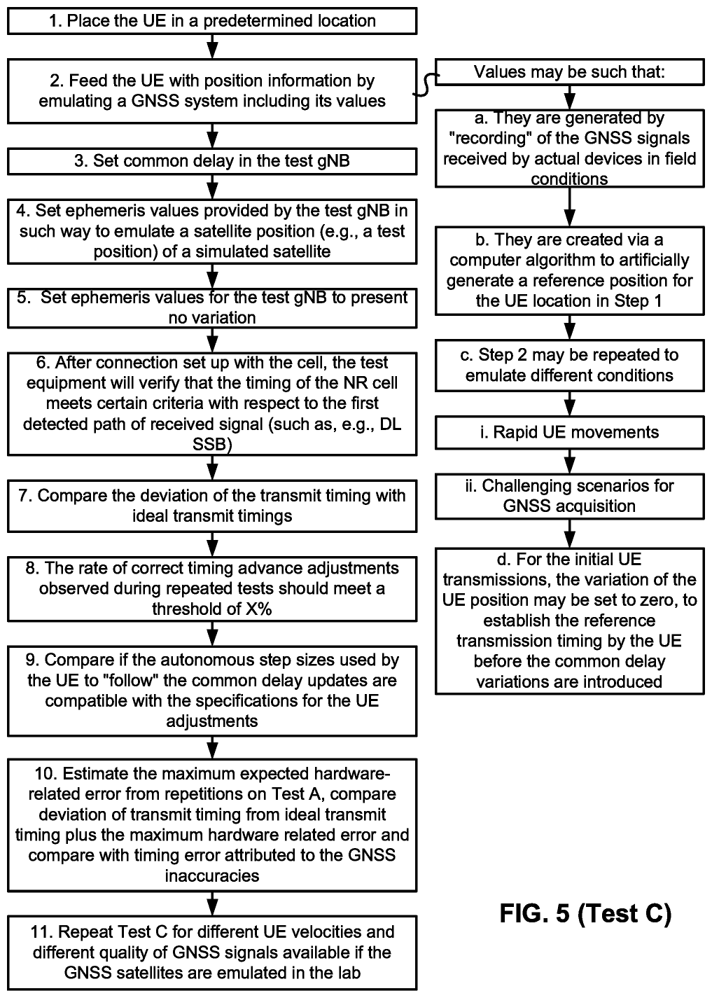

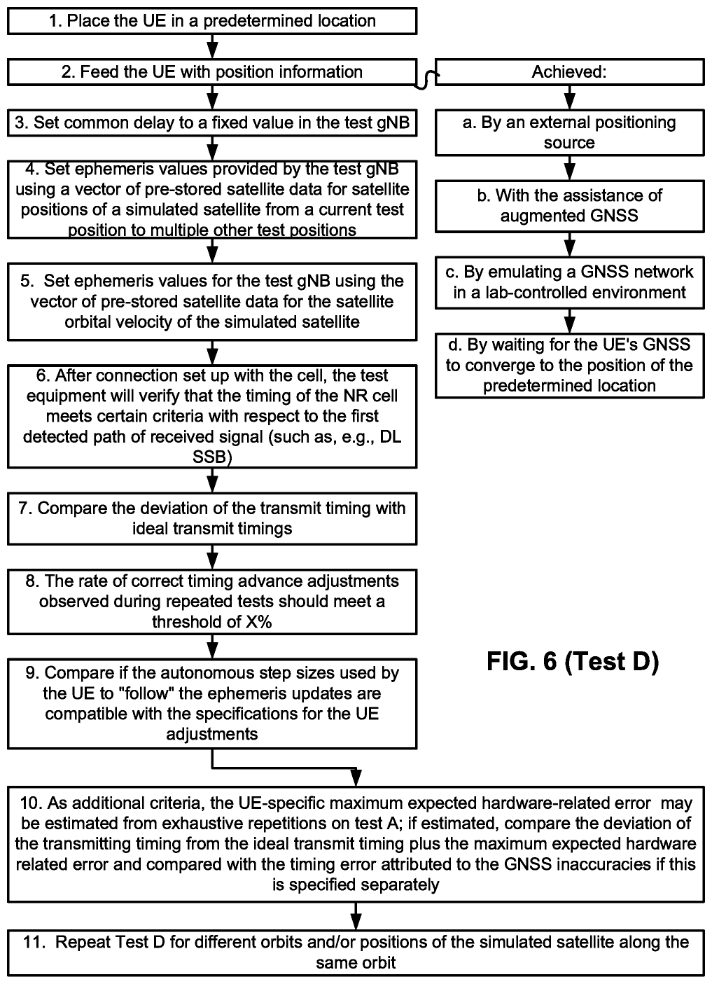

One exemplary framework that can be used for exemplary embodiments can be seen in FIG. 2, where the different input elements are seen and also whether the six different tests where different combinations of the input test vectors are present or not. There is a test block 210, which has the following inputs: true UE position 220; common delay test vector 230; UE location test vector 240; and satellite ephemeris test vector 250. Reference 260 indicates a comparison is made between UE transmit timing versus requirements. Table 270 indicates the following in corresponding columns: test cases A through F; whether a corresponding common delay case vector is present or is not present; whether a corresponding UE location test vector is or is not present; and whether a corresponding satellite ephemeris test vector is or is not present. The “present” and “not present” indications in this table are merely exemplary. Tests A-F are described below using both text and figures. FIG. 2 also shows how the tests correspond to the figures: Test A is described in FIG. 3; Test B is described in FIG. 4; Test C is described in FIG. 5; Test D is described in FIG. 6; Test E is described in FIG. 7; and Test F is described in FIG. 8.

It is noted that the common delay test vector 230, UE location test vector, 240, and satellite ephemeris test vector 250 are able to introduce error into the tests. The introduction of this error is important in the exemplary embodiments described below, which concern testing whether a UE can keep timing accurate enough if exposed to real input. This is tested by the testcases specified, where a setup is made where the perfect information (position, common delays, ephemeris) is known, but the UE is exposed to information which is non-ideal (e.g., the different testcases). The non-ideal information (position, common delay and/or ephemeris) is referred herein as information with errors. So, this is information which deviates from the “perfect” (e.g., true/real/ideal) information.

It is noted that a “baseline” may also be tested, where the baseline uses the perfect information (position via true UE position vector 220, common delays via common delay test vector 240, and ephemeris via satellite ephemeris test vector 250) that is known. Emphasis herein, however, is placed on introduction of errors in one or more of position (via UE location test vector 240), common delays (via common delay test vector 240), or ephemeris (via satellite ephemeris test vector 250). It is also noted that a single UE location test vector may be used instead of vectors 220 and 240, and this single vector can contain perfect information or information with errors.

Now that an overview has been provided, additional details are provided. Multiple examples of test setups are provided, although the exemplary embodiments are not limited to these. The test setups may comprise several testing setups that are proposed as follows.

For the purpose of determining UE transmit timings, the procedure proposed and described above for conventional systems is assumed as being the baseline (i.e., a UE transmitting SRS). This does not limit generality, as the exemplary proposed features for testing NTN specific time synchronization errors at the UE can be as well combined with other baseline mechanisms of UE synchronization testing in TN.

All tests are designed for RRC connected mode, or starting a least at a RACH procedure. Legacy steps of previous test setups may apply in between some of the steps mentioned below. The tests are categorized using letters, e.g., Test A, Test B, and the like. These are not limiting and used by way of explanation.

It is noted that it is important that the values used in the testing can be set separately, in order to evaluate the UE's response and performance to each of them separately. In a controlled lab setup, these can be set manually and/or configured by the network in a controlled way to emulate real-world NTN scenarios. A human being interfacing with the test equipment 10-1 and 10-2

Test A. Test for the transmit timing error accuracy.

In the legacy procedure, the value Tₑ was established to account for hardware inaccuracies and imprecision on the synchronization crystal on the UE side, alongside some technical limitations for perfect timing synchronization. In the absence of errors due to GNSS positioning and common delay estimation, the total transmit error contains only the errors associated to the factors used for Tₑ. In this test, the GNSS and common delay estimation errors are mitigated (or fully excluded if set to zero) to evaluate the UE's precision in fulfilling the RAN4 requirements for the transmit timing error component Tₑ.

This exemplary test works as follows. See FIG. 3, which is a logic flow diagram of an exemplary testing procedure, Test A, in accordance with an exemplary embodiment.

Step 1. Place the UE in a predetermined location.

Step 2. Feed the UE with position information. This can be achieved:
a. By an external positioning source. This could be as simple as feeding the UE the exact position to use through a user interface or through a data cable (e.g., in debug mode). Basically, the UE is provided the x,y,z position to use from an entity that is not relying on the UE's GNSS receiver.
b. With the assistance of augmented GNSS positioning assistance. Augmented GNSS refers to assisted GNSS, e.g., where as one example the GNSS is helped with some side information from other point(s) around the device. As another example, aspects of the GNSS performance (e.g., reliability, accuracy, availability) are enhanced by external sources or external information. In particular, with the assistance of GNSS augmentation, by using external sources or external information, this may increase the accuracy and reliability of GNSS information.
c. By emulating a GNSS network in lab-controlled environment. This may be performed by a GPS simulator. According to a white paper at www.orolia.com/what-is-a-gps-simulator/: “GPS simulators are radio frequency generating instruments that are capable of transmitting the same exact data as GPS satellites. However, the value of a GPS simulator is in the ability to change a wide variety of parameters right from the test bench”.
d. By waiting for the UE's GNSS to converge to the position of the predetermined location (previously calibrated by the lab). In other words, waiting for UE's GNSS to provide the same value as the lab-calibrated value for the UE position. In one example, the convergence may consider positions within the reference position by a small margin of X meters, such as within 5-10 meters (and potentially even smaller), although this is not limiting.

The UE, in response to step 2, calculates or is provided with its position.

Step 3. Set common delay to a fixed value in the test gNB (for example, set common delay=0).

Step 4. Set ephemeris values provided by the test gNB in such way to emulate a satellite position (e.g., a test position) of a simulated satellite 16. This means the ephemeris data broadcasted by the test gNB corresponds to a reference position that may be the position of the test gNB or any other reference position, chosen to emulate the very large delays experienced by UEs in NTN scenarios. As one example, in order to emulate realistic large delays, it is possible to introduce a known “delay buffer” at the gNB 170 to emulate the delay which a satellite would introduce to the signal transmission. As is known, the ephemeris information is information that will be transmitted by the gNB towards the UE either (a) in system information broadcast (SIB) or (b) using dedicated signaling (RRC signaling).

As background, satellite ephemeris is a set of parameters that describes the satellite's position and motion in space. For example, a position (x,y,z) and some kind of descriptor for the satellites movement into the short-term future (Vₓ, V_{y}, V_{z}) (e.g., a velocity vector), and long-term future (e.g., orbital parameters that describes the ellipsis that the satellite will follow while orbiting the earth). Meanwhile, the common delay in contrast is a set of parameters that describes how the delay experienced on the feeder link (link between ground station and the satellite) will change as a function of time. For this, parameters are used that correspond to a second-order polynomial (one can see this as an equation describing the time-varying timing relation between the satellite and the ground station). Due to the satellite's movement in time, a change of the common delay should be seen as time passes, and the ephemeris and common delay are related to each other, but not equal to each other (if one knows the position of the ground station (e.g., gNB) as well as the satellite ephemeris, one can calculate the distance between these two nodes, and hence be able to calculate the propagation delay as well (which is the common delay)).

Step 5. Set ephemeris values for the test gNB or the other reference position to present no variation (e.g., no satellite movement).

As part of step 4 and/or 5, the gNB broadcasts the ephemeris values to the UE. As noted above, the estimation of the delay between the UE and satellite also relies on ephemeris position, so this is created (steps 4/5) at the base station for a fixed satellite (though as described below a moving satellite may be used), and the base station sends the ephemeris position to the UE.

Step 6. After connection set up with the cell, the test equipment will verify that the timing of the NR cell meets a certain criterion or certain criteria (e.g., is within N_{TA}+N_{TA,UE-specific}+N_{TA,common}+N_{TA,offset}) with respect the first detected path of a received signal (such as, e.g., DL SSB). This step may be considered to be part of the legacy procedure.

Concerning step 6, more specifically, the “ideal TA” indicates how well the UE can transmit a signal that “arrives” at the gNB at the expected instant. So, this may be “calculated” by the gNB. But it may just be the case where the gNB expects a UE signal at a given point in time, and measures the “delta/offset” to the said point in time.

Provided that the steps 2-5 are properly set, it is possible to estimate, from the test-controlled environment, the ideal transmit time using as reference the test-gNB transmit timing (N_{TA,UE-specific} and N_{TA,common} will both be a fixed offset). In fact, if these steps are consistent, all UEs subject to the same testing procedures should expect very similar transmit timings relative to the beginning of the test. The deviation of the UE timing from the expected ideal transmission timing is the error in Tₑ.

In further detail, the UE 110 can calculate the N_{TA,UE-specific}, which as described above is an estimation of the delay between UE and the satellite (i.e., service link delay). The UE can calculate the T_{TA} from the equation above. The gNB 170 determines the TA the UE used when connecting to the gNB. The gNB can then determine the deviation of this TA with a TA the gNB calculates based on its knowledge of UE location and satellite parameters.

Step 7. Compare the deviation of the transmit timing with ideal transmit timings. The error should be inferior to the total timing error budget (e.g., T_{e,NTN}, in Eq. 1) or the combined transmit timing error, Tₑ if this is specified separately (as the other components are fixed, they should introduce no estimation error at the UE side).

At first sight, steps 6 and 7 may seem similar, but step 6 is to validate whether or not there is a connection established and that the transmit timing is according to expectation. In step 7, statistics are started to be collected of the received information (e.g., by comparing the observed transmit timing of the UE to the ideal timing to provide a deviation of transmit timing (ΔT, e.g., the T_{TA} used by the UE versus an ideal version calculated by the gNB)). The ΔT is observed over time to ensure/validate that requirements are met in step 8. So, step 6 may be thought of as a pass/fail (e.g., go/no go) decision, and step 7 may be seen as a data collection step. The pass/fail is illustrated as step 6A.

Step 8. The rate of correct timing advance adjustments observed during repeated tests should be meet a threshold of X %. It is noted that this percentage could be different for different systems/UEs, so this may be expected to be set for the particular system/UE under test. For instance, the value of X is something that would be determined during specification work-quite often values like 1%, 2% or 10% are used. The issue is that the lower the percentage value is applied, the more samples it takes to have a reliable performance test result. Hence, it is a balance between complexity and accuracy. One possible option is that the UE would not be allowed to exceed the threshold more than 10% of the times. However, a working group such as RAN4 (e.g., RAN WG4) might perform some simulations and determine a target percentage, and this might entail some discussions with interested entities such as chipset vendors. Regardless, the X % is assumed to be known prior to testing

A note about step 8 is the following. UE testing is a required step before product launching, to ensure that UEs meet the requirements as defined, e.g., by RAN4. UEs which do not meet the requirements should not be used in a 3GPP network, as they could harm the overall performance of the network, including other UE performance as well. Step 8 (and similar steps in the other figures herein) ensure that the UEs meet these criteria, and UEs that cause the system to not meet the correct timing advance adjustments observed during repeated tests and the corresponding criterion are considered as not to be used in a 3GPP network.

Another note is that the threshold of X % may be based on failures or based on successes. That is, normally when defining test cases in RAN4, they either refer to a number of failures (“at most x out of y are allowed to fail”) or the number of successes (“throughput shall be at least 90% of the reported CSI values”). These values are normally the inverse of each other. For the example of the throughput of at least 90%, the threshold of X % could be 10%, and a value of 10% or fewer failures could be used; or the threshold of X % could be 90%, and a value of 90% or more successes could be used.

To ensure compliance, additional steps may be added to Test A, as follows.

Step 9. Repeat Test A for different emulated satellite positions for the simulated satellite 16 (for example, for a different range of satellite altitudes) by changing the value of the ephemeris base on the gNB location in the test environment each time.

This step aims to ensure that the “larger” timing advance ranges do not cause instability of the UE clock. Consider the following example. For LEO satellites, the TA may vary from 2 ms, for a best-case scenario for a satellite at 300 kms of altitude, to 25 ms, for the worst-case scenario for a satellite at approximately 1500 kms.

Step 10. Repeat steps 1-9, for different UE positions. This may be achieved by using an external source to emulate UE positioning algorithms. The purpose of this test is not to test GNSS accuracy (as “perfect” location information or a known GNSS accuracy is provided at the UE) but instead test UE transmit timing accuracy.

One or both of steps 9 and 10 would likely be performed for multiple tests in order to have enough data for step 8 to be performed. This is a function of the testing procedures being performed, however.

It is noted that the information with errors described above can be introduced in FIG. 3 at least in one or more of steps 2, 9, or 10.

Test B. Test for the common delay estimation at the UE side.

See FIG. 4, which is a logic flow diagram of an exemplary testing procedure, Test B, in accordance with an exemplary embodiment. It is noted that some similar steps are performed in FIG. 3, and details for steps below that are also described with respect to FIG. 3 may be described in FIG. 3. It is also noted this applies to other, later-described figures, which may use some steps from previously-described figures, and those previously-described steps may contain more accompanying detail than later-described steps.

Step 1. Place the UE in a predetermined location.

Step 2. Feed the UE with positioning. This can be achieved:
a. By an external positioning source.
b. With the assistance of augmented GNSS positioning assistance.
c. By emulating a GNSS network in lab-controlled environment.
d. By waiting for the GNSS to converge to the position of the predetermined location (previously calibrated by the lab).

Step 3. Set common delay in the test gNB.

a. For the common delay information provided by the test-gNB, a pre-stored sequence (e.g., a vector) of realistic common delay values (T common (i), for i=1, 2, 3 . . . ) may be generated to emulate real delays between gNB->GW->Satellite. The Common delay values can be preferentially taken from real continuous measurements from a feeder link implementation and sampled at certain epoch times to generate the vector to be broadcasted.

b. The vector of common delay estimations used to obtain the common delay parameters broadcasted by the gNB may be obtained from simulations or by exporting real data from an NTN setup.

c. The common delays values obtained in subclauses a or b are then discretized, optionally the high-order momentums (e.g., TA drift rate) are estimated and interpolated according to the update rate chosen from the common delay updates at the gNB. These values are then broadcast by the gNB.

d. For the initial UE transmissions, the common delay variation may be set to zero, to establish the reference transmission timing by the UE before the common delay variations are introduced.

Step 4. Set ephemeris values provided by the test gNB to emulate a satellite position (e.g., a test position) for a simulated satellite 16.

Step 5. Set ephemeris values for the test gNB to present no variation (no-satellite movement).

Step 6. After connection set up with the cell, the test equipment will verify that the timing of the NR cell meets certain criteria (e.g., is within N_{TA}+

N_{TA,UE-specific}+N_{TA,common}+N_{TA,offset}) with respect to the first detected path of a received signal (such as, e.g., DL SSB). This step may be considered to be a legacy procedure.

Step 7. Compare the deviation of the transmit timing with the ideal transmit timings. The error should be inferior to the total timing error budget (T_{e,NTN},in Eq. 1) or the combined transmit timing error, Tₑ+T_{e,SAT} if those are specified separately (as the other components are fixed, they should introduce no estimation error at the UE side).

Step 8. The rate of correct timing advance adjustments observed during repeated tests should meet a threshold of X %.

Step 9. Compare if the autonomous step sizes used by the UE to “follow” the common delay updates are compatible with the specifications for the UE adjustments. This step may be considered to be optional. Appropriate action would be taken if the common delay updates are not compatible with the specifications for the UE adjustments, such as requiring the UE's hardware or software to be redesigned.

In this case, the test setup is estimating the quality of the UE modelling of the common delay estimation function, by interpolating the information provided by the gNB. Usually, satellite position and common delay are associated to each other, however, for testing purposes, this is not necessary. Variations on the common delay are transparent to the satellite position from the UE point of view. The test should last for an interval that is longer than at least one so-called “validity timer” value to ensure that the UE has the capability to track successfully the common delay over a sufficiently long prediction horizon. The validity timer being a parameter set by the gNB where the UE should be able to estimate the common delay from the common delay parameters (which may contain the common delay variation and higher order parameters for estimation) without reacquiring updated information. Optimally, the choice of validity timer and common delay parameters to be broadcast (and their precision) should reflect the most challenging scenario.

As in the Test A, the ideal transmission timing at the UE side is highly predictable, using the known real values T_{common} for the common delay (feeder link).

A number of optional steps are also possible.

Step 10. As additional criteria, the UE-specific maximum expected hardware related error, Tₑ, here called T_{e,specific}, may be estimated from the exhaustive repetitions on test A. If estimated, compare the deviation of the transmit timing from the ideal transmit timing plus the maximum expected hardware-related error (T_{e,specific}) and compare with T_{e,SAT} if this is specified separately. As with step 9, appropriate action would be taken if the comparison(s) indicate the UE does not meet specification(s).

Step 11. Steps 9 and 10 should be repeated for the duration of several validity timers, in order to explore the quality of the UE algorithm to model the common delay variation with aging information within the validity timer and if the refresh rate used by the UE to reacquire common delay information is compliant with the validity timer values.

To ensure compliance, additional steps may be added to Test B, which are the following steps.

Step 12. Repeat Test B for different emulated satellite positions for the simulated satellite 16 (for example, for a different range of satellite altitudes).

Step 13. Repeat steps 1-10, for different common delay vectors, Ť_{common}(i).

It is noted that the information with errors described above can be introduced in FIG. 4 at least in one or more of steps 2, 12, or 13.

Test C. Test for the service link delay, PART 1: UE GNSS related inaccuracies.

Test C is illustrated by FIG. 5, which is a logic flow diagram of an exemplary testing procedure, in accordance with an exemplary embodiment. For test C, one goal is to measure the quality of GNSS estimations at the UE side. This may be achieved by emulating the GNSS system on a lab-controlled environment. In this case, transmitters are placed in the lab to radiate GNSS-like signals, such that the position of the UE can be “spoofed” to generate any desired position.

Step 1. Place the UE in a predetermined location.

Step 2. Emulate a GNSS system, as described above. The values for the emulated system, may be such that:
a. They are generated by “recording” of the GNSS signals received by actual devices in field conditions, i.e., data collection of actual GNSS signals.
b. They are created via a computer algorithm to artificially generate a reference position for the UE location in Step 1.
c. Step 2 may be repeated to emulate different conditions:
i. Rapid UE movements—emulating a train or airplane trajectory.
ii. Challenging scenarios for GNSS acquisition, i.e., considering also samples where a low number of satellites is available.
d. For the initial UE transmissions, the variation of the UE position may be set to zero, to establish the reference transmission timing by the UE before the common delay variations are introduced.

Step 2 establishes the baseline (e.g., being provided “perfect data”) for a GNSS system. This baseline is used below for inaccuracy (i.e., error) determinations.

Step 3. Set common delay to a fixed value in the test gNB (for example, set common delay=0).

Step 4. Set ephemeris values provided by the test gNB to emulate a satellite position (e.g., a test position) of a simulated satellite 16.

Step 5. Set ephemeris values for the test gNB to present no variation (no-satellite movement).

Step 6. After connection set up with the cell, the test equipment will verify that the timing of the NR cell is within N_{TA}+N_{TA,UE-specific}+N_{TA,common}+N_{TA,offset} with respect to the first detected path of a received signal (such as, e.g., DL SSB). This step may be considered to be a legacy procedure.

Step 7. Compare the deviation of the transmit timing with the ideal transmit timings. The error should be inferior to the total timing error budget (T_{e,NTN},in Eq. 1) or the combined transmit timing error, Tₑ+T_{e,GNSS} if those are specified separately (as the other components are fixed, they should introduce no estimation error at the UE side).

Step 8. The rate of correct timing advance adjustments observed during repeated tests should meet a threshold of X %.

Step 9. Compare if the autonomous step sizes used by the UE to “follow” the common delays are compatible with the specifications for the UE adjustments. This step is optional.

Provided that Steps 2-5 are properly set, it is possible to estimate, from the test-controlled environment the ideal transmit time using as reference the test-gNB transmit timing. For this, the ideal transmitting time is determined by using the “expected” UE position, with perfect estimation in the autonomous timing advance compensation formula.

A number of optional steps are possible, including the following.

Step 10. As additional criteria, the UE-specific maximum expected Tₑ, here called T_{e,specific}, may be estimated from the exhaustive repetitions on Test A. If so, compare the deviation of the transmit timing from the ideal transmit timing plus the maximum expected hardware related error (T_{e,specific}) and compare with T_{e,GNSS} if this is specified separately.

To ensure compliance additional steps may be added to Test C:

Step 11. Repeat Test C for different UE velocities and different quality of GNSS signals available if the GNSS satellites are emulated in the lab. In general terms, step 11 repeats the test with other input sources that may cause the timing to be different. By testing different signals provided through step 11, it is possible to see if the UE's transmit timing exceeds the expected threshold (e.g., relative to the baseline in step 2).

With respect to GNSS error, this may mainly be observed in step 9, but step 8 should also be considered (e.g., since this is comparing the correct timing advance adjustments to the total amount of timing advance adjustments).

It is noted that the information with errors described above can be introduced in FIG. 5 at least in one or more of steps 2, 9, or 10.

Test D. Test for the service link delay, PART 2: Inaccuracies on the satellite position estimation (ephemeris).

FIG. 6 is a logic flow diagram of an exemplary testing procedure, Test D, in accordance with an exemplary embodiment. Likewise, as proposed for test B, a sequence of ephemeris positions (e.g., a vector of data) is pre-stored, either by collecting real data from a satellite control center, or by simulating orbital positions with high update rate, such as every 10 ms in one non-limiting example. The real position of the satellite is used to estimate the UE transmit timing using the reference the downlink reception timing. Among others, this test will verify the quality of the UE algorithm to estimate satellite position from the orbit parameters broadcast in the ephemeris. The choice of the “test ephemeris data” should be such that the data represents a valid satellite position for the UE in the current UE location or current emulated location for the UE.

Step 1. Place the UE in a predetermined location.

Step 2. Feed the UE with position information. This can be achieved:
a. By an external positioning source.
b. With the assistance of augmented GNSS positioning assistance.
c. By emulating a GNSS network in lab-controlled environment.
d. By waiting for the GNSS to converge to the position of the predetermined location (previously calibrated by the lab).

Step 3. Set common delay to a fixed value in the test gNB (for example, set common delay=0).

Step 4. Set ephemeris values provided by the test gNB using a vector of pre-stored satellite data for satellite positions of a simulated satellite 16 from a current test position to multiple other test positions. The values may be discretized and sampled according to the specifications for ephemeris broadcast signaling.

Step 5. Set ephemeris values for the test gNB using the vector of pre-stored satellite data for the satellite orbital velocity of the simulated satellite 16. The values must be discretized and sampled according to the specifications for ephemeris broadcast signaling.

Step 6. After connection set up with the cell, the test equipment will verify that the timing of the NR cell meets certain criteria (e.g., is within N_{TA}+N_{TA,UE-specific}+N_{TA,common}+N_{TA,offset}) with respect to the first detected path of a received signal (such as, e.g., DL SSB). This step may be considered to be a legacy procedure.

Step 7. Compare the deviation of the transmit timing with the ideal transmit timings. The error should be inferior to the total timing error budget (T_{e,NTN}, in Eq. 1) or the combined transmit timing error, Tₑ+T_{e,GNSS} if those are specified separately (as the other components are fixed, they should introduce no estimation error at the UE side).

Step 8. The rate of correct timing advance adjustments observed during repeated tests meet a threshold of X %.

Step 9. Compare if the autonomous step sizes used by the UE to “follow” the ephemeris updates are compatible with the specifications for the UE adjustments.

In this case, the test setup is estimating the quality of the UE modelling of the common delay estimation function, by interpolating the information provided by the gNB for the ephemeris. The test should last for an interval that equals a few “validity timer” values. The validity timer being a parameter set by the gNB where the UE should be able to estimate the propagation delay from the UE position to the satellite position, using as reference the ephemeris information broadcasted by the network without reacquiring updated information. Optimally, the choice of validity timer and common delay parameters to be broadcast (and their precision) should reflect the most challenging scenario.

To ensure compliance, additional steps may be added to Test D:

Step 10. As additional criteria, the UE-specific maximum expected hardware-related error Tₑ, here called T_{e,specific}, may be estimated from exhaustive (e.g., greater than a threshold) repetitions on test A. If estimated, compare the deviation of the transmitting timing from the ideal transmit timing plus the maximum expected hardware related error (T_{e,specific}) and compared with T_{e,GNSS} (the timing error attributed to the GNSS inaccuracies) if this is specified separately.

Step 11. Repeat Test D for different orbits and/or positions of the simulated satellite 16 along the same orbit.

It is noted that the information with errors described above can be introduced in FIG. 6 at least in one or more of steps 2, 4, 10, or 11.

Test E. Test for the service link delay.

FIG. 7 is a logic flow diagram of an exemplary testing procedure, Test E, in accordance with an exemplary embodiment. For this test, the procedures of tests C and D are combined.

Test F. Test for the service and feeder link delay.

FIG. 8 is a logic flow diagram of an exemplary testing procedure, Test F, in accordance with an exemplary embodiment. In this test, the procedures of tests B and E are combined.

It is noted that many of the operations in the blocks of Tests A-F may be performed via the test equipment 10, e.g., possibly under control in part by a human operator. For instance, for FIG. 3 (Test A), steps 1 and 3-10 could be performed by the test equipment 10, but the (e.g., error-free) feeding of the UE by positioning information may not be performed by the test equipment.

As described above with respect to claim 2 and concerning introducing errors, in FIGS. 2-8 it is possible that the position information, common delay, and ephemeris values may be without error in the sense that these values track real satellite locations or orbits. This assumes “perfect” information is used. This perfect information may be used in FIG. 2, where the true UE position vector 220, the common delay test vector 230, and the satellite ephemeris test vector 250 are applied potentially as part of Tests A-F. However, the common delay test vector 230, UE location test vector 240 (e.g., which can modify the true UE position vector 220), and the satellite ephemeris test vector 250 may also introduce errors for the tests as described above, which may be different depending on different tests (e.g., FIG. 4, Test B, concerns response to common delays in part, while FIG. 3, Test A, concerns response to UE position in part). In fact, the same test might be performed with both “perfect” (e.g., error-free) vector(s) and vector(s) with errors introduced. The errors, in particular, test whether a UE can keep timing accurate enough if exposed to real input. The perfect vectors might be used to form a baseline, while the errors test whether UE accuracy is within limits.

For example, an exact position and corresponding position information for the UE could be known. Specifications could provide, however, that the position information may have errors of X, such that position information within Real Position Information+/−X is supposed to be able to be handled by the UE without timing errors. The Real Position Information+X and/or Real Position Information-X could be applied by the Test(s) herein, as errors in the position information. The timing errors from the UE could be evaluated and determined whether to be in compliance or not with corresponding specification(s). Similar errors could additionally or alternatively be introduced to common delays and/or ephemeris.

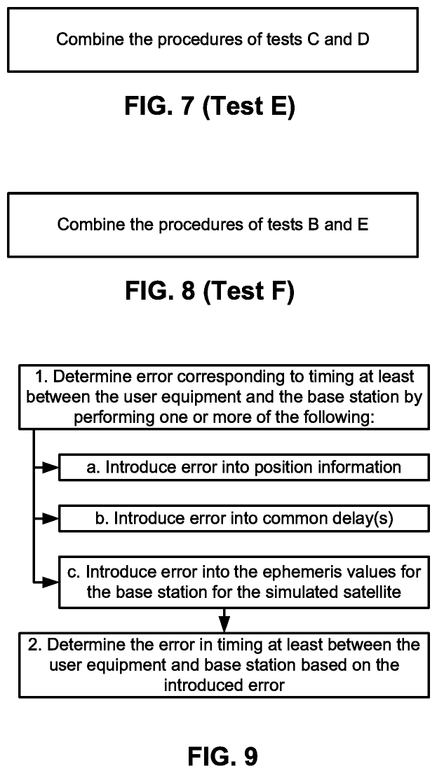

FIG. 9 is a general example where errors can be introduced in these values. FIG. 9 is a logic flow diagram that can be used in any of the Tests A-F, in accordance with an exemplary embodiment.

In step 1, the test equipment 10 determines error corresponding to timing at least between the user equipment and the base station by performing one or more of the following: a. Introduce error into position information; b. Introduce error into common delay(s); or c. Introduce error into the ephemeris values for the base station for the simulated satellite. In step 2, the test equipment 10 determines the error in timing at least between the user equipment and base station based on the introduced errors.

Specific applications of these may be applied to the corresponding Test. Consider Test A, FIG. 3, as an example. Error corresponding to timing between the user equipment and the base station may be determined, for instance, in steps 7, 8, 9, and 10. The introduced error could be with respect to at least steps 2, 9, and/or 10, and the error in timing would be determined with respect to the introduced error.

It should be noted that the testing for the UE transmit timing is performed by the network test equipment (e.g., test equipment 10) by registering the arrival time of the gNB signal at the device antenna port (in the DL frequency band), and comparing this to the UL transmit timing (first signal in the uplink band)). Knowing the expected timing advance (and common delay(s), expected UE specific TA values), it is possible to see whether requirements are met or not.

Without in any way limiting the scope, interpretation, or application of the claims appearing below, a technical effect and advantage of one or more of the example embodiments disclosed herein include that this provides a uniform test which tests the UE timing when exposed for the different error sources, which will lead to all UEs behaving similarly.

The following are additional examples.

Example 1. A method, comprising:
setting one or more common delays for a base station, the base station and a user equipment able to communicate via signals and to use the one or more common delays in communication, wherein the one or more common delays correspond to delay in communication of the signals in a path from a simulated satellite to a reference point, where the reference point is a point selected between the base station and the simulated satellite and where the user equipment is placed in a known location;
setting ephemeris values for the base station for the simulated satellite and causing the ephemeris values to be broadcasted toward the user equipment, wherein the ephemeris values represent positioning of the simulated satellite through which the signals are supposed to travel; and
in response to communication over the path by the user equipment, determining error corresponding to at least timing at least between the user equipment and the reference point.

Example 2. The method as in example 1, wherein the user equipment is placed in the known location at least by feeding the user equipment that has been placed in a location with position information for the user equipment, the position information indicating the known location.

Example 3. The method as in either example 1 or 2, wherein:
determining error corresponding to timing at least between the user equipment and the base station further comprises performing one or more of the following:
introducing error into position information initially indicating the known location;
introducing error into the one or more common delays; or
introducing error into the ephemeris values for the base station for the simulated satellite; and
determining the error in timing at least between the user equipment and base station based on the introduced error.

Example 4. The method as in any one of examples 1 to 3, wherein determining error corresponding to timing between the user equipment and the base station further comprises determining error corresponding to one or more of the following: transmit timing between the user equipment and the reference point; the one or more common delays; or the ephemeris values.

Example 5. The method as in any one of examples 1 to 4, wherein:
the method further comprises, after connection set up between the user equipment and the base station corresponding to the connecting, comparing deviation of transmit timing with one or more ideal transmit timings; and
the determining error comprises determining whether a rate of correct timing advance adjustments observed during repeated tests meets a criterion.

Example 6. The method as in example 5, further comprising, prior to the determining whether a rate of correct timing advance adjustments observed during repeated tests meets a criterion and after the connection set up with the user equipment and the base station, verifying that transmit timing between the user equipment and base station meets a certain criterion with respect to a first detected path of one or more downlink synchronization signal blocks for at least one of the repeated tests, wherein the determining whether a rate of correct timing advance adjustments observed is performed for the at least one repeated test only in response to the transmit timing between the user equipment and base station meeting the certain criterion.

Example 7. The method as in any one of examples 5 or 6, wherein the one or more common delays comprise a plurality of common delays and corresponding updates set to emulate real delays between at least the base station and the simulated satellite, the common delays and updates set by one of the following:
a) for common delay information, a pre-stored sequence of realistic common delay values has been generated to emulate real delays between at least the base station and the simulated satellite;
b) a vector of common delay estimations has been obtained from simulations or by exporting real data from a non-terrestrial network setup;
c) common delays values obtained in subclauses a or b are discretized, and the discretized values are broadcast by the base station; or
d) for initial transmissions by the user equipment, a common delay variation is set to zero, to establish a reference transmission timing by the user equipment before other common delay variations are introduced.

Example 8. The method as in example 7, wherein the determining error further comprises:
comparing whether autonomous step sizes used by the user equipment to follow the common delay updates are compatible with one or more specifications for the timing advance adjustments by the user equipment.

Example 9. The method as in one of examples 7 or 8, wherein the determining error further comprises:
estimating a maximum expected hardware-related error from repeated tests;
comparing deviation of transmit timing from ideal transmit timing plus the maximum hardware related error; and
comparing deviation of transmit timing with timing error attributed to inaccuracies on the ephemeris position.

Example 10. The method as in any one of examples 5 or 6, further comprising feeding the user equipment with position information by emulating a global satellite navigation system including its values.

Example 11. The method as in example 10, wherein the values fed by feeding the user equipment with position information by emulating the global satellite navigation system are performed by one of the following:
a) the values are generated by recording of global satellite navigation system signals received by actual devices in field conditions;
b) the values are created via a computer algorithm to artificially generate a reference position for the location in which the user equipment is placed;
c) the feeding the user equipment with position information by emulating a global satellite navigation system is repeated to emulate different conditions for one or both of the following:
i) rapid movements of the user equipment; or
ii) scenarios for acquisition of signals for the global satellite navigation system that are considered to be challenging;
d) for initial transmissions by the user equipment, variation of the position of the user equipment is set to zero, to establish the reference transmission timing by the user equipment before common delay variations are introduced.

Example 12. The method as in either example 10 or 11, wherein the determining error further comprises:
comparing whether autonomous step sizes used by the user equipment to follow common delay updates are compatible with one or more specifications for the timing advance adjustments by the user equipment.

Example 13. The method as in one of examples 10 to 12, wherein the determining error further comprises:
estimating a maximum expected hardware-related error from repeated tests;
comparing deviation of transmit timing from ideal transmit timing plus the maximum hardware related error; and
comparing deviation of transmit timing with timing error attributed to inaccuracies for the global satellite navigation system.

Example 14. The method as in any one of examples 1 to 6, wherein setting ephemeris values for the base station for at least a current test position further comprises setting ephemeris values and corresponding updates for the base station using a plurality of values for satellite positions from the current test positions to multiple other test positions to emulate satellite movement based at least on orbital velocity of the simulated satellite.

Example 15. The method as in example 14, wherein the determining error further comprises:
comparing whether autonomous step sizes used by the user equipment to follow the ephemeris updates corresponding to the emulated satellite movement are compatible with one or more specifications for the timing advance adjustments by the user equipment.

Example 16. The method as in one of examples 14 or 15, wherein the determining error further comprises:
estimating a maximum expected hardware-related error from repeated tests;
comparing deviation of transmit timing from ideal transmit timing plus the maximum hardware related error; and
comparing the deviation of transmit timing with timing error attributed to inaccuracies in the global satellite navigation system.

Example 17. The method as in any one of examples 7 to 9 or 14 to 16, wherein the user equipment is fed with the position information using one of the following:
by an external positioning source;
with the assistance of augmented global satellite navigation system positioning assistance;
by emulating a global satellite navigation system network; or
by waiting for a global satellite navigation system of the user equipment to converge to a position of a predetermined location corresponding to the location.

Example 18. The method as in one of examples 10 or 11 and as in one of examples 14 to 16.

Example 19. The method as in example 18 and as in one of examples 8 or 9.

Example 20. A computer program, comprising code for performing the methods of any of examples 1 to 19, when the computer program is run on a computer.

Example 21. The computer program according to example 20, wherein the computer program is a computer program product comprising a computer-readable medium bearing computer program code embodied therein for use with the computer.

Example 22. The computer program according to example 20, wherein the computer program is directly loadable into an internal memory of the computer.

Example 23. An apparatus comprising means for performing:
setting one or more common delays for a base station, the base station and a user equipment able to communicate via signals and to use the one or more common delays in communication, wherein the one or more common delays correspond to delay in communication of the signals in a path from a simulated satellite to a reference point, where the reference point is a point selected between the base station and the simulated satellite and where the user equipment is placed in a known location;
setting ephemeris values for the base station for the simulated satellite and causing the ephemeris values to be broadcasted toward the user equipment, wherein the ephemeris values represent positioning of the simulated satellite through which the signals are supposed to travel; and
in response to communication over the path by the user equipment, determining error corresponding to at least timing at least between the user equipment and the reference point.

Example 24. The apparatus as in example 23, wherein the user equipment is placed in the known location at least by feeding the user equipment that has been placed in a location with position information for the user equipment, the position information indicating the known location.

Example 25. The apparatus as in either example 23 or 24, wherein:
determining error corresponding to timing at least between the user equipment and the base station further comprises performing one or more of the following:
introducing error into position information initially indicating the known location;
introducing error into the one or more common delays; or
introducing error into the ephemeris values for the base station for the simulated satellite; and
determining the error in timing at least between the user equipment and base station based on the introduced error.

Example 26. The apparatus as in any one of examples 23 to 25, wherein determining error corresponding to timing between the user equipment and the base station further comprises determining error corresponding to one or more of the following: transmit timing between the user equipment and the reference point; the one or more common delays; or the ephemeris values.

Example 27. The apparatus as in any one of examples 23 to 26, wherein:
the means are further configured for performing: after connection set up between the user equipment and the base station corresponding to the connecting, comparing deviation of transmit timing with one or more ideal transmit timings; and
the determining error comprises determining whether a rate of correct timing advance adjustments observed during repeated tests meets a criterion.

Example 28. The apparatus as in example 27, wherein the means are further configured for performing: prior to the determining whether a rate of correct timing advance adjustments observed during repeated tests meets a criterion and after the connection set up with the user equipment and the base station, verifying that transmit timing between the user equipment and base station meets a certain criterion with respect to a first detected path of one or more downlink synchronization signal blocks for at least one of the repeated tests, wherein the determining whether a rate of correct timing advance adjustments observed is performed for the at least one repeated test only in response to the transmit timing between the user equipment and base station meeting the certain criterion.

Example 29. The apparatus as in any one of examples 27 or 28, wherein the one or more common delays comprise a plurality of common delays and corresponding updates set to emulate real delays between at least the base station and the simulated satellite, the common delays and updates set by one of the following:
a) for common delay information, a pre-stored sequence of realistic common delay values has been generated to emulate real delays between at least the base station and the simulated satellite;
b) a vector of common delay estimations has been obtained from simulations or by exporting real data from a non-terrestrial network setup;
c) common delays values obtained in subclauses a or b are discretized, and the discretized values are broadcast by the base station; or
d) for initial transmissions by the user equipment, a common delay variation is set to zero, to establish a reference transmission timing by the user equipment before other common delay variations are introduced.

Example 30. The apparatus as in example 29, wherein the determining error further comprises:
comparing whether autonomous step sizes used by the user equipment to follow the common delay updates are compatible with one or more specifications for the timing advance adjustments by the user equipment.

Example 31. The apparatus as in one of examples 29 or 30, wherein the determining error further comprises:
estimating a maximum expected hardware-related error from repeated tests;
comparing deviation of transmit timing from ideal transmit timing plus the maximum hardware related error; and
comparing deviation of transmit timing with timing error attributed to inaccuracies on the ephemeris position.

Example 32. The apparatus as in any one of examples 27 or 28, wherein the means are further configured for performing: feeding the user equipment with position information by emulating a global satellite navigation system including its values.

Example 33. The apparatus as in example 32, wherein the values fed by feeding the user equipment with position information by emulating the global satellite navigation system are performed by one of the following:
a) the values are generated by recording of global satellite navigation system signals received by actual devices in field conditions;
b) the values are created via a computer algorithm to artificially generate a reference position for the location in which the user equipment is placed;
c) the feeding the user equipment with position information by emulating a global satellite navigation system is repeated to emulate different conditions for one or both of the following:
i) rapid movements of the user equipment; or
ii) scenarios for acquisition of signals for the global satellite navigation system that are considered to be challenging;
d) for initial transmissions by the user equipment, variation of the position of the user equipment is set to zero, to establish the reference transmission timing by the user equipment before common delay variations are introduced.

Example 34. The apparatus as in either example 32 or 33, wherein the determining error further comprises:
comparing whether autonomous step sizes used by the user equipment to follow common delay updates are compatible with one or more specifications for the timing advance adjustments by the user equipment.

Example 35. The apparatus as in one of examples 32 to 34, wherein the determining error further comprises:
estimating a maximum expected hardware-related error from repeated tests;
comparing deviation of transmit timing from ideal transmit timing plus the maximum hardware related error; and
comparing deviation of transmit timing with timing error attributed to inaccuracies for the global satellite navigation system.

Example 36. The apparatus as in any one of examples 23 to 28, wherein setting ephemeris values for the base station for at least a current test position further comprises setting ephemeris values and corresponding updates for the base station using a plurality of values for satellite positions from the current test positions to multiple other test positions to emulate satellite movement based at least on orbital velocity of the simulated satellite.

Example 37. The apparatus as in example 36, wherein the determining error further comprises:
comparing whether autonomous step sizes used by the user equipment to follow the ephemeris updates corresponding to the emulated satellite movement are compatible with one or more specifications for the timing advance adjustments by the user equipment.

Example 38. The apparatus as in one of examples 36 or 37, wherein the determining error further comprises:
estimating a maximum expected hardware-related error from repeated tests;
comparing deviation of transmit timing from ideal transmit timing plus the maximum hardware related error; and
comparing the deviation of transmit timing with timing error attributed to inaccuracies in the global satellite navigation system.

Example 39. The apparatus as in any one of examples 29 to 31 or 36 to 38, wherein the user equipment is fed with the position information using one of the following:
by an external positioning source;
with the assistance of augmented global satellite navigation system positioning assistance;
by emulating a global satellite navigation system network; or
by waiting for a global satellite navigation system of the user equipment to converge to a position of a predetermined location corresponding to the location.

Example 40. The apparatus as in one of examples 32 or 33 and as in one of examples 36 to 38.

Example 41. The apparatus as in example 40 and as in one of examples 30 or 31.

Example 42. The apparatus of any preceding apparatus example, wherein the means comprises:
at least one processor; and
at least one memory including computer program code, the at least one memory and computer program code configured to, with the at least one processor, cause the performance of the apparatus.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 50 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the figures are defined as follows:

| | |
|---|---|
| 3GPP | third generation partnership project |
| 5G | fifth generation |
| 5GC | 5G core network |
| AMF | access and mobility management function |
| BS | base station |
| CM | control module |
| CU | central unit |
| DL | downlink (from network, via a base station, to |
| | the UE) |
| DU | distributed unit |
| eNB (or eNodeB) | evolved Node B (e.g., an LTE base station) |
| EN-DC | E-UTRA-NR dual connectivity |
| en-gNB or En-gNB | node providing NR user plane and control plane |
| | protocol terminations towards the UE, and |
| | acting as secondary node in EN-DC |
| E-UTRA | evolved universal terrestrial radio access, i.e., |
| | the LTE radio access technology |
| FFS | for future study |
| FR1 | frequency range 1 |
| FR2 | frequency range 2 |
| gNB (or gNodeB) | base station for 5G/NR, i.e., a node providing |
| | NR user plane and control plane protocol |
| | terminations towards the UE, and connected via |
| | the NG interface to the 5GC |
| GNSS | global satellite navigation system |
| GW | gateway |
| I/F | interface |
| LEO | low-Earth orbit |
| LTE | long term evolution |
| MAC | medium access control |
| MME | mobility management entity |
| ng or NG | next generation |
| ng-eNB or NG-eNB | next generation eNB |
| NR | new radio |
| NTN | non-terrestrial network |
| N/W or NW | network |
| PDCP | packet data convergence protocol |
| PHY | physical layer |
| PRACH | physical RACH |
| RACH | random access channel |
| RAN | radio access network |
| Rel. | release |
| RLC | radio link control |
| RRH | remote radio head |
| RRC | radio resource control |
| RU | radio unit |
| Rx | receiver |
| SCS | sub-carrier spacing |
| SDAP | service data adaptation protocol |
| SGW | serving gateway |
| SMF | session management function |
| SRS | sounding reference signal |
| SSB | synchronization signal block |
| TA | timing advance |
| TN | terrestrial network |
| TS | technical specification |
| Tx | transmitter |
| UE | user equipment (e.g., a wireless, typically |
| | mobile device) |
| UL | uplink (from UE to network) |
| UPF | user plane function |

1. A method, comprising:
setting one or more common delays for a base station, the base station and a user equipment able to communicate via signals and to use the one or more common delays in communication, wherein the one or more common delays correspond to delay in communication of the signals in a path from a simulated satellite to a reference point, where the reference point is a point selected between the base station and the simulated satellite and where the user equipment is placed in a known location;
setting ephemeris values for the base station for the simulated satellite and causing the ephemeris values to be broadcasted toward the user equipment, wherein the ephemeris values represent positioning of the simulated satellite through which the signals are supposed to travel; and
in response to communication over the path by the user equipment, determining error corresponding to at least timing at least between the user equipment and the reference point.

2. The method as in claim 1, wherein the user equipment is placed in the known location at least by feeding the user equipment that has been placed in a location with position information for the user equipment, the position information indicating the known location.

3. The method as in claim 1, wherein:
determining error corresponding to timing at least between the user equipment and the base station further comprises performing one or more of the following:
introducing error into position information initially indicating the known location;
introducing error into the one or more common delays; or
introducing error into the ephemeris values for the base station for the simulated satellite; and
determining the error in timing at least between the user equipment and base station based on the introduced error.

4. The method as in claim 1, wherein determining error corresponding to timing between the user equipment and the base station further comprises determining error corresponding to one or more of the following: transmit timing between the user equipment and the reference point; the one or more common delays; or the ephemeris values.

5. The method as in claim 1, wherein:
the method further comprises, after connection set up between the user equipment and the base station corresponding to the connecting, comparing deviation of transmit timing with one or more ideal transmit timings; and
the determining error comprises determining whether a rate of correct timing advance adjustments observed during repeated tests meets a criterion.

6. The method as in claim 5, further comprising, prior to the determining whether a rate of correct timing advance adjustments observed during repeated tests meets a criterion and after the connection set up with the user equipment and the base station, verifying that transmit timing between the user equipment and base station meets a certain criterion with respect to a first detected path of one or more downlink synchronization signal blocks for at least one of the repeated tests, wherein the determining whether a rate of correct timing advance adjustments observed is performed for the at least one repeated test only in response to the transmit timing between the user equipment and base station meeting the certain criterion.

7. The method as in claim 5, wherein the one or more common delays comprise a plurality of common delays and corresponding updates set to emulate real delays between at least the base station and the simulated satellite, the common delays and updates set by one of the following:
a) for common delay information, a pre-stored sequence of realistic common delay values has been generated to emulate real delays between at least the base station and the simulated satellite;
b) a vector of common delay estimations has been obtained from simulations or by exporting real data from a non-terrestrial network setup;
c) common delays values obtained in subclauses a or b are discretized, and the discretized values are broadcast by the base station; or
d) for initial transmissions by the user equipment, a common delay variation is set to zero, to establish a reference transmission timing by the user equipment before other common delay variations are introduced.

8-9. (canceled)

10. The method as in claim 5, further comprising feeding the user equipment with position information by emulating a global satellite navigation system including its values.

11. The method as in claim 105, further comprising feeding the user equipment with position information by emulating a global satellite navigation system including its values, wherein the values fed by feeding the user equipment with position information by emulating the global satellite navigation system are performed by one of the following:
a) the values are generated by recording of global satellite navigation system signals received by actual devices in field conditions;
b) the values are created via a computer algorithm to artificially generate a reference position for the location in which the user equipment is placed;
c) the feeding the user equipment with position information by emulating a global satellite navigation system is repeated to emulate different conditions for one or both of the following:
i) rapid movements of the user equipment; or
ii) scenarios for acquisition of signals for the global satellite navigation system that are considered to be challenging;
d) for initial transmissions by the user equipment, variation of the position of the user equipment is set to zero, to establish the reference transmission timing by the user equipment before common delay variations are introduced.

12. The method as in claim 5, further comprising feeding the user equipment with position information by emulating a global satellite navigation system including its values, wherein the determining error further comprises:
comparing whether autonomous step sizes used by the user equipment to follow common delay updates are compatible with one or more specifications for the timing advance adjustments by the user equipment.

13. The method as in claim 5, further comprising feeding the user equipment with position information by emulating a global satellite navigation system including its values, wherein the determining error further comprises:
estimating a maximum expected hardware-related error from repeated tests;
comparing deviation of transmit timing from ideal transmit timing plus the maximum hardware related error; and
comparing deviation of transmit timing with timing error attributed to inaccuracies for the global satellite navigation system.

14. The method as in claim 1, wherein setting ephemeris values for the base station for at least a current test position further comprises setting ephemeris values and corresponding updates for the base station using a plurality of values for satellite positions from the current test positions to multiple other test positions to emulate satellite movement based at least on orbital velocity of the simulated satellite.

15. The method as in claim 14, wherein the determining error further comprises:
comparing whether autonomous step sizes used by the user equipment to follow the ephemeris updates corresponding to the emulated satellite movement are compatible with one or more specifications for the timing advance adjustments by the user equipment.

16. The method as in claim 14, wherein the determining error further comprises:
estimating a maximum expected hardware-related error from repeated tests;
comparing deviation of transmit timing from ideal transmit timing plus the maximum hardware related error; and
comparing the deviation of transmit timing with timing error attributed to inaccuracies in the global satellite navigation system.

17. The method as in claim 14, wherein the user equipment is fed with the position information using one of the following:
by an external positioning source;
with the assistance of augmented global satellite navigation system positioning assistance;
by emulating a global satellite navigation system network; or
by waiting for a global satellite navigation system of the user equipment to converge to a position of a predetermined location corresponding to the location.

18-22. (canceled)

23. An apparatus comprising
at least one processor; and
at least one memory including computer program code, the at least one memory and computer program code configured to, with the at least one processor, cause the apparatus to perform at least:
setting one or more common delays for a base station, the base station and a user equipment able to communicate via signals and to use the one or more common delays in communication, wherein the one or more common delays correspond to delay in communication of the signals in a path from a simulated satellite to a reference point, where the reference point is a point selected between the base station and the simulated satellite and where the user equipment is placed in a known location;
setting ephemeris values for the base station for the simulated satellite and causing the ephemeris values to be broadcasted toward the user equipment, wherein the ephemeris values represent positioning of the simulated satellite through which the signals are supposed to travel; and
in response to communication over the path by the user equipment, determining error corresponding to at least timing at least between the user equipment and the reference point.

24. The apparatus as in claim 23, wherein the user equipment is placed in the known location at least by feeding the user equipment that has been placed in a location with position information for the user equipment, the position information indicating the known location.

25. The apparatus as in claim 23, wherein:
determining error corresponding to timing at least between the user equipment and the base station further comprises performing one or more of the following:
introducing error into position information initially indicating the known location;
introducing error into the one or more common delays; or
introducing error into the ephemeris values for the base station for the simulated satellite; and
determining the error in timing at least between the user equipment and base station based on the introduced error.

26. The apparatus as in claim 23, wherein determining error corresponding to timing between the user equipment and the base station further comprises determining error corresponding to one or more of the following: transmit timing between the user equipment and the reference point; the one or more common delays; or the ephemeris values.

27. The apparatus as in claim 23, wherein:
the at least one memory and computer program code configured to, with the at least one processor, cause the apparatus to perform: after connection set up between the user equipment and the base station corresponding to the connecting, comparing deviation of transmit timing with one or more ideal transmit timings; and
the determining error comprises determining whether a rate of correct timing advance adjustments observed during repeated tests meets a criterion.

28-42. (canceled)
